(19) United States
(12) Patent Application Publication
(10) Pub. No.: US 2004/0230540 A1
(43) Pub. Date: Nov. 18, 2004

(54) Method and system for regulating access to a service

(76) Inventors: Stephen James Crane, Bristol (GB); David John Carroll, Shirley Croydon (GB)

Correspondence Address: HEWLETT-PACKARD COMPANY, Intellectual Property Administration, P.O. Box 272400, Fort Collins, CO, 80527-2400, US

(21) Appl. No.: 10/699,598

(22) Filed: Oct. 30, 2003

(30) Foreign Application Priority Data
May 15, 2003 (GB) 0306003.5
May 29, 2003 (GB) 0312233.0

(51) Int. Cl. G06F 17/60

(52) U.S. Cl. 705/76

(57) ABSTRACT

To regulate access to a service provided by a service provider, a service authoriser generates for each of multiple service time periods a different respective data set comprising private data and related public data. The service provider uses the public data for a current time period and an encryption key string to generate encrypted data which a party wanting to receive the service must decrypt. The service authoriser provides a decryption key to the party after determining that the party is entitled to receive the service for a particular service time period; the decryption key is generated using the aforesaid encryption key string and the private data of the data set for the service period concerned. The party can then decrypt the encrypted data it receives provided that the period for which the data has been encrypted is the same as that for which the decryption key was generated.

### FIELD OF THE INVENTION

The present invention relates to a method and system for regulating access to a service by time periods.

As used herein, references to a service are to be broadly understood to encompass any type of service including, without limitation, transactional services, information services and services that provide access to a data component such as software or digital media content.

### BACKGROUND OF THE INVENTION

Access to a service, such as a service provided over the internet, frequently requires the party wishing to receive the service first to obtain authorisation to do so from an authorisation authority. Once this authority has determined that the party is entitled to the receive the service (as a result, for example, of the party making an appropriate payment), the authority may provide the party with an element evidencing that the party is entitled to receive the service. The party then presents this element to the provider of the service in order to receive the service. The authorisation authority may be part of the service provider organisation or may be an independent body trusted by the service provider and possibly acting on behalf of multiple different service providers.

The nature of the element provided to the party by the authorisation authority to enable the party to prove its entitlement to a service will depend on the degree of security required. Thus, in some instances a simple unencrypted password may be sufficient whilst in other instances a more secure cryptographic-based arrangement (such as one using PKI technology) may be justified.

Entitlement to a service will generally be time limited. This can be achieved, for example, by having the proof-of-entitlement element include an expiry date or by the service provider running a check before providing the service to the party.

Existing approaches to regulating service access on a time basis and in a secure manner are generally inefficient and expensive both in terms of processing time and communications bandwidth. Furthermore, user anonymity is generally not accommodated.

It is an object of the present invention to provide an improved way of regulating access to a service by time periods.

The present invention is in part based on the appreciation that Identifier-Based Encryption (IBE) has certain properties that can be adapted for use in regulating access to a service by time periods.

Identifier-Based Encryption (IBE) is an emerging cryptographic schema. In this schema (see FIG. 1 of the accompanying drawings), a data provider 10 encrypts payload data 13 using both an encryption key string 14, and public data 15 provided by a trusted authority 12. This public data 15 is derived by the trusted authority 12 using private data 17 and a one-way function 18. The data provider 10 then provides the encrypted payload data <13> to a recipient 11 who decrypts it, or has it decrypted, using a decryption key computed by the trusted authority 12 in dependence on the encryption key string and its own private data.

A feature of identifier-based encryption is that because the decryption key is generated from the encryption key string, its generation can be postponed until needed for decryption.

Another feature of identifier-based encryption is that the encryption key string is cryptographically unconstrained and can be any kind of string, that is, any ordered series of bits whether derived from a character string, a serialized image bit map, a digitized sound signal, or any other data source. The string may be made up of more than one component and may be formed by data already subject to upstream processing. In order to avoid cryptographic attacks based on judicious selection of a key string to reveal information about the encryption process, as part of the encryption process the encryption key string is passed through a one-way function (typically some sort of hash function) thereby making it impossible to choose a cryptographically-prejudicial encryption key string. In applications where defence against such attacks is not important, it would be possible to omit this processing of the string.

Frequently, the encryption key string serves to “identify” the intended message recipient and the trusted authority is arranged to provide the decryption key only to this identified intended recipient. This has given rise to the use of the label “identifier-based” or “identity-based” generally for cryptographic methods of the type under discussion. However, depending on the application to which such a cryptographic method is put, the string may serve a different purpose to that of identifying the intended recipient and may be used to convey other information to the trusted authority or, indeed, may be an arbitrary string having no other purpose than to form the basis of the cryptographic processes. Accordingly, the use of the term “identifier-based” or “IBE” herein in relation to cryptographic methods and systems is to be understood simply as implying that the methods and systems are based on the use of a cryptographically unconstrained string whether or not the string serves to identify the intended recipient. Generally, in the present specification, the term “encryption key string” or “EKS” is used rather than “identity string” or “identifier string”; the term “encryption key string” is also used in the shortened form “encryption key” for reasons of brevity.

A number of IBE algorithms are known and FIG. 2 indicates, for three such algorithms, the following features, namely:

the form of the encryption parameters 5 used, that is, the encryption key string and the public data of the trusted authority (TA);

the conversion process 6 applied to the encryption key string to prevent attacks based on judicious selection of this string;

the primary encryption computation 7 effected;

the form of the encrypted output 8.

The three prior art IBE algorithms to which FIG. 2 relates are:

Quadratic Residuosity (QR) method as described in the paper: C. Cocks, “An identity based encryption scheme based on quadratic residues”, Proceedings of the 8^{th} IMA International Conference on Cryptography and Coding LNCS 2260, pp 360-363, Springer-Verlag, 2001. A brief description of this form of IBE is given hereinafter.

Bilinear Mappings p using, for example, a Tate pairing t or modified Weil pairing ê. Thus, for the modified Weil pairing:

ê: G₁×G₁→G₂

where G₁ and G₂ denote two algebraic groups of prime order q and G₂ is a subgroup of a multiplicative group of a finite field. The Tate pairing (to which the example given in FIG. 2 specifically relates) can be similarly expressed though it is possible for it to be of asymmetric form:

t: G₁×G₀→G₂

where G₀ is a further algebraic group the elements of which are not restricted to being of order q. Generally, the elements of the groups G₀ and G₁ are points on an elliptic curve though this is not necessarily the case. A description of this form of IBE method, using modified Weil pairings is given in the paper: D. Boneh, M. Franklin—“Identity-based Encryption from the Weil Pairing” in Advances in Cryptology—CRYPTO 2001, LNCS 2139, pp. 213-229, Springer-Verlag, 2001.

RSA-Based methods The RSA public key cryptographic method is well known and in its basic form is a two-party method in which a first party generates a public/private key pair and a second party uses the first party's public key to encrypt messages for sending to the first party, the latter then using its private key to decrypt the messages. A variant of the basic RSA method, known as “mediated RSA”, requires the involvement of a security mediator in order for a message recipient to be able to decrypt an encrypted message. An IBE method based on mediated RSA is described in the paper “Identity based encryption using mediated RSA”, D. Boneh, X. Ding and G. Tsudik, 3rd Workshop on Information Security Application, Jeju Island, Korea, August, 2002.

A more detailed description of the QR method is given below with reference to the entities depicted in FIG. 1 and using the same notation as given for this method in FIG. 2. In the QR method, the trust authority's public data 15 comprises a value N that is a product of two random prime numbers p and q, where the values of p and q are the private data 17 of the trust authority 12. The values of p and q should ideally be in the range of 2⁵¹¹ and 2⁵¹² and should both satisfy the equation: p, q≡3 mod 4. However, p and q must not have the same value. Also provided is a hash function # which when applied to a string returns a value in the range 0 to N-1.

Each bit of the user's payload data 13 is then encrypted as follows:

The data provider 10 generates random numbers t₊(where t₊is an integer in the range [0, 2^{N}]) until a value of t₊is found that satisfies the equation jacobi(t₊,N)=m′, where m′ has a value of -1 or 1 depending on whether the corresponding bit of the user's data is 0 or 1 respectively. (As is well known, the jacobi function is such that where x²≡#mod N the jacobi (#, N)=-1 if x does not exist, and =1 if x does exist). The data provider 10 then computes the value:

s₊≡(t₊+K/t₊)modN

where: s₊corresponds to the encrypted value of the bit m′ concerned, and

K=#(encryption key string)

Since K may be non-square, the data provider additionally generates additional random numbers t_(integers in the range [0, 2^{N})) until one is found that satisfies the equation jacobi(t_, N)=m′. The data provider 10 then computes the value:

s_{—}≡(t_{—}−K/t_)modN

as the encrypted value of the bit m concerned.

The encrypted values s₊and s₋for each bit m′ of the user's data are then made available to the intended recipient 11, for example via e-mail or by being placed in a electronic public area; the identity of the trust authority 12 and the encryption key string 14 will generally also be made available in the same way.

The encryption key string 14 is passed to the trust authority 12 by any suitable means; for example, the recipient 11 may pass it to the trust authority or some other route is used-indeed, the trust authority may have initially provided the encryption key string. The trust authority 12 determines the associated private key B by solving the equation:

B²≡K modN (“positive” solution)

If a value of B does not exist, then there is a value of B that is satisfied by the equation:

B²≡−K modN (“negative” solution)

As N is a product of two prime numbers p, q it would be extremely difficult for any one to calculate the decryption key B with only knowledge of the encryption key string and N. However, as the trust authority 12 has knowledge of p and q (i.e. two prime numbers) it is relatively straightforward for the trust authority 12 to calculate B.

Any change to the encryption key string 14 will result in a decryption key 16 that will not decrypt the payload data 13 correctly. Therefore, the intended recipient 11 cannot alter the encryption key string before supplying it to the trust authority 12.

The trust authority 12 sends the decryption key to the data recipient 11 along with an indication of whether this is the “positive” or “negative” solution for B.

If the “positive” solution for the decryption key has been provided, the recipient 11 can now recover each bit m′ of the payload data 13 using:

m′=jacobi(s_{—}+2B,N)

If the “negative” solution for the decryption key B has been provided, the recipient 11 recovers each bit m′ using:

m′=jacobi(s₋+2B,N)

### SUMMARY OF THE INVENTION

According to one aspect of the present invention, there is provided a method of regulating access to at least one service provided by at least one service provider, wherein a service authoriser:

generates for each of multiple service time periods a different respective data set comprising private data and related public data; and

determines whether a party is entitled to receive a said service for a particular said time period and, if so, provides that party with a decryption key for accessing the service during said particular time period, the decryption key being generated by the authoriser in dependence on both an arbitrary encryption key string associated with the service, and the private data of the data set for said particular time period.

The encryption key string can be chosen by the party, the service provider or the service authoriser, depending on the embodiment concerned; the encryption key string is arbitrary in that it is cryptographically unconstrained.

The party uses the decryption key to decrypt encrypted data provided to the party by the service provider, decryption of this data being necessary in order for the party to receive the service for a current said time period; the encrypted data is data encrypted by the service provider using the aforesaid encryption key and the public data of the data set for said current time period. The party is only able to decrypt the encrypted data using the decryption key provided by the authoriser where the particular time period for which the decryption key was generated is said current time period. Thus, service provision is automatically terminated at the end of the current service time period unless the party obtains (or has obtained) the decryption key applicable to the following service time period from the service authoriser.

According to another aspect of the present invention, there is provided a computing entity for regulating access to at least one service provided by at least one service provider, the computing entity comprising:

first means for generating for each of multiple service time periods a different respective data set comprising private data and related public data;

second means for determining whether a party is entitled to receive a said service for a particular said time period;

third means for providing a party that the second means has determined is entitled to receive the service, with a decryption key for accessing the service during said particular time period, the third means including key-generating means for generating the decryption key in dependence on both an arbitrary encryption key associated wit the service, and the private data of the data set for said particular time period.

According to a further aspect of the present invention, there is provided a system for regulating access to a service provided by a service provider, the system comprising:

a first computer entity for authorising access to said service, comprising:

first means for generating for each of multiple service time periods a different respective data set comprising private data and related public data;

second means for determining whether the party is entitled to receive the service for a particular said time period;

third means for providing a party that the second means has determined is entitled to receive the service, with a decryption key for accessing the service during said particular time period, the third means including key-generating means for generating the decryption key in dependence on both an arbitrary encryption key associated with the service, and the private data of the data set for said particular time period;

a second computer entity, associated with the service provider, and arranged to provide said party with encrypted data which the party is required to decrypt to receive the service for a current said time period, the second computer entity being arranged to form said encrypted data by encrypting data based on said encryption key string and the public data of the data set for said current time period; and

a third computer entity, associated with said party, and arranged to use the decryption key provided by the first computer entity to decrypt the encrypted data provided by the second computer entity, the third computer entity only being able to decrypt the encrypted data using said decryption key where the said particular time period is said current time period.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the operation of a prior art encryption schema known as Identifier-Based Encryption (IBE);

FIG. 2 is a diagram illustrating how certain IBE operations are implemented by three different prior art IBE methods; and

FIG. 3 is a diagram of an embodiment of the present invention;

FIG. 4 is a diagram showing, for multiple services provided over multiple time slots, the use of different cryptographic data sets for each combination of service and time slot;

FIG. 5 is a diagram showing, for one service provided over four time slots, service time periods defined to correspond to each time slot and each time-ordered combination of two or more adjacent time slot; and

FIG. 6 is a diagram showing, for three services provided over multiple time slots, the use of three different cryptographic data sets for enabling a party to gain access to each service during respective time periods.

### BEST MODE FOR CARRYING OUT THE INVENTION

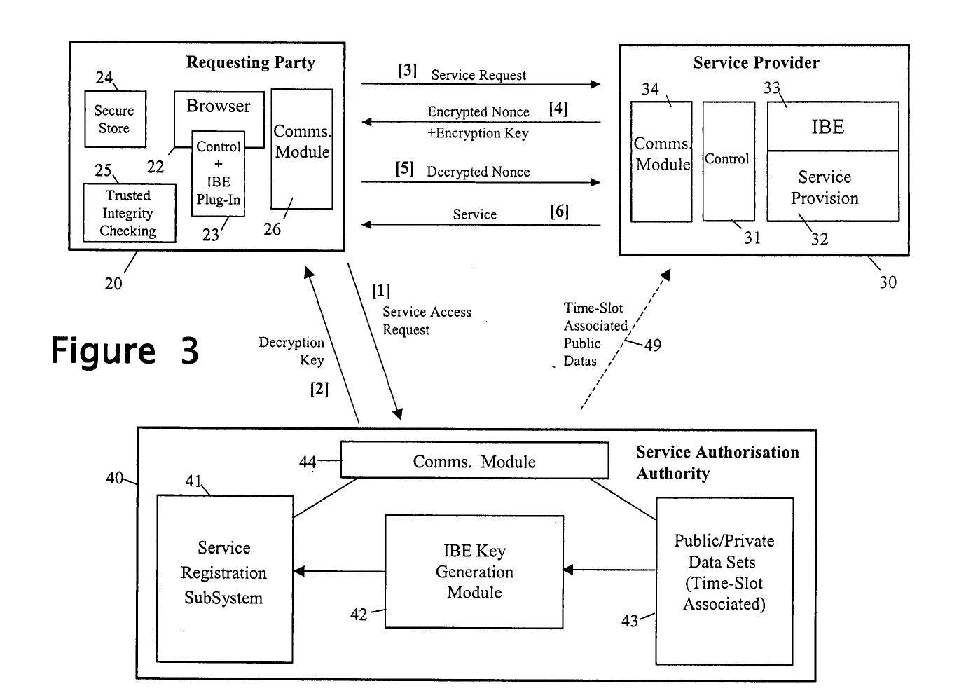

FIG. 3 illustrates a system in which a requesting party using a computing entity 20 is arranged to request a service from a service provider that is using a computing entity 30, the service only being accessible to the party if the party has or can obtain a key to decrypt data provided in encrypted form by the service provider. The requesting party can obtain the required decryption key from an authorisation authority that is using a computing entity 40.

The computing entities 20, 30 and 40 inter-communicate as needed via, for example, the internet or other computer network though it is also possible that two or all three entities actually reside on the same computing platform.

In the following, references to the requesting party, service provider and authorisation authority are generally used interchangeably with references to their respective computing entities 20, 30, 40.

The authorisation authority 40 is arranged to determine whether the requesting party 20 is entitled to receive the service during a particular time period (the service being received once, multiple times or continuously during this period depending on the nature of the service and, potentially, on the extent to which the party is entitled to receive the service). After the authorisation authority 40 has determined that the party is entitled to receive the service, it provides the party with a decryption key which will enable the party to decrypt encrypted data provided by the service provider during the time period for which the party is entitled to receive the service; the provided decryption key will not decrypt data provided by the service provider outside of the time period for which the party is entitled to receive the service.

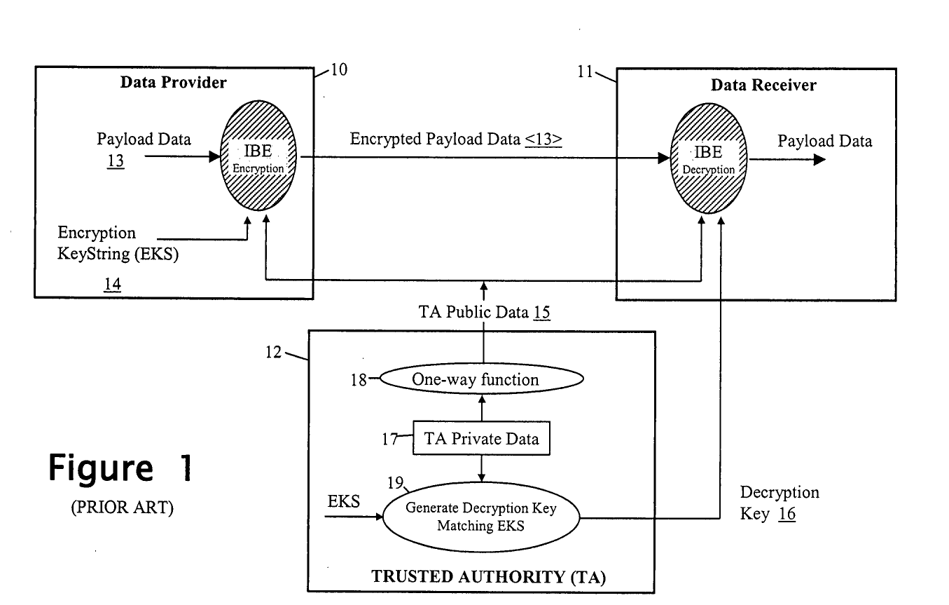

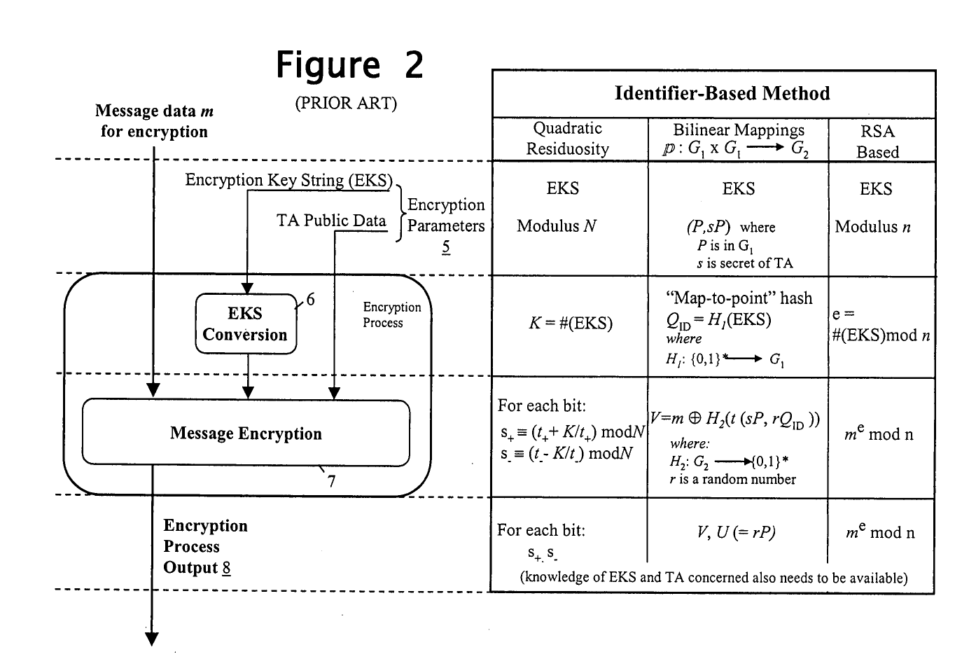

This is achieved using Identifier-Based Encryption with the computing entities 20, 30 and 40 having roles (so far as the IBE cryptographic processes are concerned) corresponding to those of data recipient 11, the data provider 10, and trusted authority 12 of the FIG. 1 IBE arrangement. More particularly, the authorisation authority 40 is arranged to generate for each of multiple service time periods, a different respective data set comprising private data and related public data (thus, for the QR IBE method described above, each data set comprises different values of the parameters p, q and N). The service provider 30, in providing encrypted data to the party 20 during a current time period, uses an encryption key string and the public data for the current service time period to encrypt the data it sends to the party. The authorisation authority 40 on determining that the party is entitled to receive the service during the aforesaid particular time period, uses the private data for that period and the aforesaid encryption key string to generate the decryption key. This decryption key will only be useful in decrypting the data provided by the service provider when the time period in which the encrypted data was provided equals the time period associated with the decryption key (the period for which the party is entitled to receive the service).

Considering the FIG. 3 system in more detail, the requesting-party entity 20 comprises a browser 22 providing a user interface for managing interaction with the service-provider entity 30 and authorisation-authority entity 40; a secure data store 24 holding the decryption key (or keys) provided by the authorisation authority; a trusted integrity checking module 25; and a communications module 24 for communicating with the other entities 30, 40. The browser 22 has a plug-in 23 provided, for example, by the authorisation-authority entity 40. The plug-in provides both control functionality for coordinating the operations of the entity 20 to be described below, and the IBE functionality needed by the entity 20. Where the QR IBE method is being used, the plug-in 23 thus contains the program code for decrypting data using a decryption key provided by the entity 40 and the public data N for the service time period to which the decryption key relates.

It will be appreciated that the party 20 should preferably be unable to share the decryption key(s) it receives with any other party. It is for this reason that the decryption key is arranged to be held in secure store 24 with the entity 20 being a trusted platform that can be interrogated in a trustable manner to confirm that the key is securely held and only used by particular processes. Thus, the decryption key is, for example, held in protected storage associated with a TPM (trusted platform module) and unsealed for use as described in:

TCPA—Trusted Computing Platform Alliance Main Specification v1.1, www.trustedcomputing.org, 2001.

Mechanisms suitable for enabling the entity 40 to assure itself that entity 20 is a trusted platform operating as expected are also described in the above document and are represented in FIG. 3 by the trusted integrity checking module 25.

The service-provider entity 30 comprises a control module 31 for controlling the operations, to be described below, that ensure that during any given service period, service provision is limited to parties having the decryption key appropriate for that period; a service provision module 32 arranged to effect service provision as permitted by the control module 31; an IBE encryption module 33 (in the present example implementing the QR method and therefore employing an encryption key string, the public data N for the current service time period, and hash function #); and a communications module for communicating with the entities 20 and 40.

In the present example, it will be assumed that the encryption key string used in the IBE encryption process by module 33 and in the decryption-key generation process carried out by the authorisation authority is well known and invariant across the service time periods. The encryption key string is, for example, an identifier (such as a name) of the service generated by one of the authorisation authority 40 and the service provider 30 and made available both to the other of the service provider and authorisation authority, and to the party 20.

The authorisation-authority entity 40 comprises:

a communications module 44 for communicating with the entities 20 and 30;

a service registration subsystem 41 for determining whether parties are entitled to receive the service provided by the service provider 30 during particular time periods and for providing entitled parties with the corresponding decryption keys appropriate for the periods for which they are entitled to receive the service;

a decryption-key generation module 42 for responding to a request from the subsystem 41 for a decryption key for a specific time period, by generating the required key (using the encryption key string and the appropriate private data value) and providing it to the subsystem 41; and

a data-set generation module 43 for generating respective data sets (each comprising different values of private data and related public data) for each service time period, the key generation module 42 obtaining from the module 43 the required private data value for the time period in respect of which the subsystem 41 has requested a decryption key.

The service time periods, are, for example, successive 24 hr periods or successive hour periods during a working day (service time periods may or may not run up against each other or, as will be explained below, may overlap with each other).

The service registration subsystem 41 determines whether the party 20 is entitled to receive the service according to conditions specified by the service provider; for example, the sole condition may be payment of a service fee by the party 20 (which may be done by personal attendance of party 20 at an office of the authorisation authority 40, or electronically). The conditions that a party must meet to receive the service may vary between service time periods. Whatever conditions are imposed on service provision, it is the responsibility of the subsystem 41 to determine that party 20 is entitled to receive the service for a particular time period only if all conditions are met; the service provider 20 “trusts” the authorisation authority to ensure that this is the case.

The value of the public data N for the current service time period is made available to the service provider 30 (see dashed arrow 49) in any suitable manner; for example, this value may be “pushed” to the entity 30, “pulled” by the latter from the entity 40, or simply published by the entity 40 for general access. Appropriate security measures may be taken to ensure that the value of N is not subverted in its provision to the service provider 30; thus the value of N may be sent over a link secured by a symmetric-key cryptographic arrangement.

Having described the components of entities 20, 30 and 40, a description will now be given of the process by which the requesting party gains access to a service available from the service provider for a particular time period. In the FIG. 3 embodiment, this process comprises the following steps:

[1] The party 20 requests service access by registering for the service with the authorisation authority 40 and requesting service access (this may be done by personal attendance or electronically). In the present example, the request is assumed to be for service access during the current service time period without the party needing to specify this in the request.

[2] Upon the authorisation authority 40 receiving the service-access request from party 20, the subsystem 31 first checks whether the party 20 is entitled to receive the service by having met the associated access conditions specified by the service provider 30 (including payment of any prescribed service fee). The entity 40 may also check at this stage that the computing entity 20 is a trusted platform that can be trusted to store and use the decryption key without revealing it to other parties. If the party is entitled to receive the service for the current time period and if the computing entity passes any trusted-platform check carried out, the subsystem 31 requests the key generation module 42 to generate the decryption key for the current time period. The module 42 does this using the well-known encryption key string and the private data for the current time period (this private data being obtained from module 43). On receiving the required decryption key from the module 42, the subsystem 41 returns the key to the party 20. The party 20 stores the decryption key in secure store 24.

[3] At some point during the time period associated with the decryption key stored by the party 20, the party 20 makes a service request to the service provider 30. The party 20 does not identify itself to the service provider 30.

[4] Upon the service request being received at the service provider, the control module 31 causes the IBE module 33 to encrypt arbitrary data using both the well-known encryption key string and the value of the public data N for the current time period (as judged by a clock, not shown). The control module 31 returns the encrypted data to the requesting party 20.

[5] The requesting party 20 uses its stored decryption key to decrypt the encrypted data received from the service provider 30. The decrypted data is then sent back to the service provider 30 to prove that the party 20 is entitled to receive the service during the current time period.

[6] The control module 31 of the service-provider entity 30 checks that the decrypted data received from the party 20 matches the original data and if this is case, the control module 31 enables the service provision module 32 to proceed with provision of the service requested by the party 20.

The service provider 30 is thus able to fulfill the party's service request even when the service provider has had no prior relationship with the user. The service provider 30 does not need to know the identity of the party 20 and can be assured that after the end of the service time period for which the party 20 has been authorized, any service elements subsequently made available by the service provider will be inaccessible to the party 20. Of course, the party can contact the authorisation authority 40 again to obtain the decryption key applicable to the next service time period, subject to the authority authorizing the party for that period.

The above-described approach to regulating service access on a time basis is efficient and inexpensive both in terms of processing time and communications bandwidth.

In a variant of the FIG. 3 process, the encrypted data sent by the service provider 30 to the requesting party (arrow [4] in FIG. 3) is a data component of the service, such as software or digital media content (the service being, in effect, the provision of such items in accessible form); the requesting party can only access (decrypt) and use the data component if that party has the decryption key corresponding to the time period in which the service provider made the encrypted data component available. In this case, steps [5] and [6] will generally not be needed. It may also be noted that where the encrypted component effectively encompasses the service to be provided so that the party does not need to go back to the service provider, the party 20 can defer decryption of the encrypted component beyond expiration of the time period in which the encrypted data was provided, the decryption key for that period still being effective for data encrypted in the period.

In a further variant of the FIG. 3 embodiment, the data-set generation module 43 of the authorisation authority 40 is arranged to generate and store data sets for future time periods. This enables the party to request service access for future time periods, the periods of interest being specified in the request sent to the authorisation authority. In response to such a request, the subsystem 31 provides the appropriate decryption key for the or each future time period in respect of which the requesting party is determined as being entitled to receive the service. The decryption keys are generated by the module 42 using the private data of the data set generated by module 43 for the periods concerned.

The public data values of the generated future-period data sets N are preferably made available by the module 43 to enable the party 20 (and service provider 30) to store these values for future use; this may be useful, for example, where the entity 20 may not be able to communicate with the authorisation authority at the time the party wants to receive the service from the service provider.

By way of example, where the service time periods are formed by successive ten minute periods, the module 43 can be arranged to generate and store data sets for every service time period present in a time window spanning the next seven days, the public data of each such data set being made available for access to the party 20 and service authority 30. As each service time period elapses, the corresponding data set would be deleted from the module 43 and a new data set generated for the service time period that has newly appeared in the seven-day time window (at its future end).

Rather than deleting the data sets of elapsed time periods, these data sets could be retained (for example, transferred to an archive) such that they are still available for use. This enables the party to obtain the decryption key appropriate for decrypting service data encrypted by the service provided during a past time period (the party 20 may have been entitled at the time to decrypt the data but has lost the key, or the party may have subsequently become entitled to access the encrypted data). The service provider 30 may itself keep an archive of encrypted data it has provided during past time periods.

The FIG. 3 arrangement can be extended to permit the party 20, if appropriately entitled, to obtain access to more than one service provided by the service provider 30 (or, indeed, by respective service providers) potentially for different periods. In this case, the authorisation authority is arranged to provide the party with at least one decryption key appropriate for the or each service and the or each time period for which the party has been determined as entitled, the decryption keys for each of said multiple services in the same time period being different from each other. In one implementation, the same data set (public and private data values) is used for each service during the same time period; in this case, the encryption key strings used for each service are different from each other and, conveniently, the party 20 identifies the service in which it is interested by providing the corresponding encryption key string (to the authority 40 when requesting a decryption key for the service, and to the service provider 30 when requesting the service itself). In an alternative implementation, a different data set is used for each service during the same time period; in this case, the encryption key string can either be service specific or be the same for all services (in which case the party 20 must identify the service of interest in some other manner, for example, by the value of N associated with the service for the current time period).

In the foregoing description of the FIG. 3 embodiment the encryption key string was well known. However, it is also possible for the party 20 to generate the encryption key string and provide it to the authority 40 and service provider 30. Where the encryption key string serves to identify the service desired by the party 20, it is the responsibility of the service provider to correctly map the supplied service identifier to the most appropriate one of the services on offer. Where different access conditions apply for different services, the authorisation authority will also need to map the service identifier to an available service in order to determine whether the party is entitled to receive that service; of course, the authorisation authority and service provider should be consistent with each other in mapping a service identifier to an available service.

With respect to the service time periods, it will be appreciated that the party 20, the service provider 30 and the authorisation authority 40 should have a common understanding about when each period starts and stops. This can be achieved in a number of ways; however, in a preferred arrangement, the time over which service(s) are available (for example, during each working day) is divided into time slots, typically of the same predetermined duration. For example, the time slots could be of 15 minute duration and for every hour start on the hour, quarter past the hour, half past the hour, and a quarter to the (next) hour. This schedule of time slots would be made known to everyone involved. The party 20 can then request service provision for one or more specified time slots.

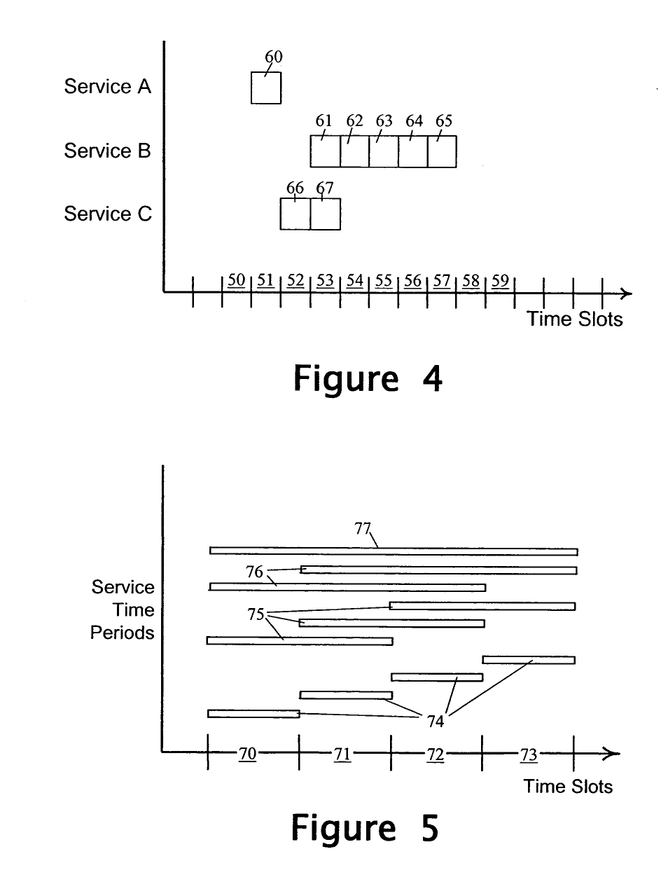

As regards the relationship between the time slots and the service time periods in respect of which respective data sets are generated by the module 43, the simplest approach is for there to be a direct one-to-one relationship—each time slot is effectively a service time period and no other such periods exist. This approach is illustrated in FIG. 4 where each successive time slot 50-59 constitutes a service time period for which there is a corresponding data set generated by module 43. In the FIG. 4 example, there are three services A, B and C on offer and the party 20 has become entitled to receive service A during one time slot 51, service B during five time slots 53-57 and service C during two time slots 52, 53. Each service has a corresponding encryption key string and the key generation module 42 is arranged to generate an appropriate decryption key for each combination of service and time slot for which the party is entitled to have service access, each decryption key being generated using the encryption key string of the relevant service and the private data of the data set of the relevant time slot. Thus, the party 20 is provided with:

decryption key 60 for accessing service A during time slot 51;

decryption keys 61-65 for accessing service B during time slots 53-57 respectively; and

decryption keys 66, 67 for accessing service C during time slots 52, 53 respectively.

In addition to there being a respective service time period for each time slot, it is also possible to define a service time period (with an associated data set) that spans multiple time slots—such a time period covering multiple time slots (not necessarily adjacent slots) is referred to below as a ‘compound’ service time period for convenience. In this case, the subsystem 31, on determining that the party is entitled to receive a service for all time slots of a compound time period, causes a single decryption key to be generated and provided to the party using the private data of the data set for the compound time period; as a result, the party only has to handle one decryption key rather than a decryption key for each time slot making up the compound time period. The service provider must, of course, encrypt the data to be provided to the party using the public data value of the data set of the compound time period (this maybe in addition to encrypting the data using the public data of the data set for the current time slot.).

Compound service time periods can be used in a number of interesting ways. For example, for a group of successive time slots, each time slot and each of every possible time-ordered combination of at least two adjacent time slots can be taken as constituting a respective service time period for which a corresponding data set is generated by the module 43. In this case, for any single period in respect of which the party is entitled to receive a service during the time interval covered by the group of time slots, the authorisation authority need only provide a single decryption key to the party. However, the service provider will now either need to know the time period for which the party has the corresponding decryption key so that it can encrypt its data using the appropriate public data value, or must provide multiple versions of its encrypted data to the party, each version being encrypted using the public data value associated with a respective one of the multiple time periods that cover the current time slot.

An example of such an arrangement is illustrated in FIG. 5 which shows for a service provided over four time slots 70-73, service time periods 74-77 defined to correspond to each time slot and each time-ordered combination of two or more adjacent time slots. Thus, four time periods 74 correspond to respective ones of the time slots 70-73′ three time periods 75 correspond to respective pairs of adjacent time slots 70+71, 71+72, 72+73; two time periods 76 correspond to respective triplets of adjacent time slots 70+71+72, 71+72+73; and one time period 77 corresponds to the combination of all four time slots 70+71+72+73. For each service time period 74-77 there is a corresponding data set generated by the module 43. It can be seen that for the time slot 71, for example, unless the service provider knows for which time period the party has the decryption key, it will need to respond to a service request by that party by encrypting data using the public data value of the data set of each of six time periods. For this reason, it is preferable that the party identify to the service provider the time period for which the party has the decryption key.

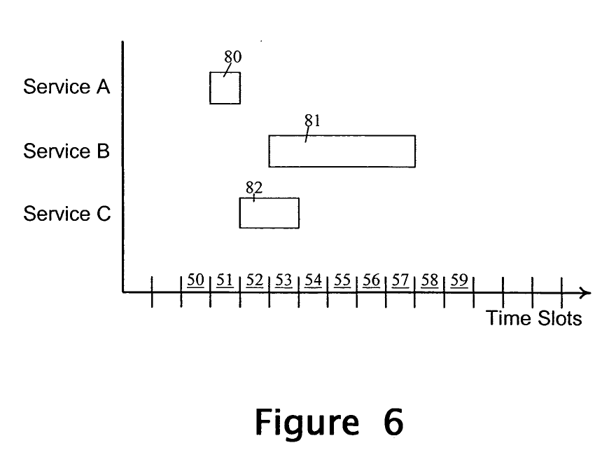

By applying the approach illustrated in FIG. 5 to the FIG. 4 scenario, it is now only necessary for the authorisation authority to supply the party 20 with three decryption keys 80, 81 and 82, one for each service, as illustrated in FIG. 6.

An example implementation concerning provision of services to a tourist is given below, with reference to the corresponding elements of FIG. 3:

A tourist (party 20) first registers with the Tourist Registration Authority (the authorisation authority 40). The authority 40 offers access to various services for up to 7 days in advance in multiples of 1-hour time slots. The tourist selects a service and a time period over which the tourist wishes to receive the service. The service is described using an arbitrary bit stream that serves as the encryption key string. The tourist pays the authority a fee for the service and upon payment being confirmed, the authority generates the corresponding decryption key for the service and time period requested (it is assumed that an arrangement similar to that illustrated in FIG. 5 is being operated so that only a single decryption key is required for any single combination of time slots for a particular service). The authority 40 installs the decryption key and the relevant public data value in the tourist's PDA along with a trusted application that the user will use to access the service, e.g. in the case of a tourist guide service, this might be an audio player.

The tourist uses the application on the PDA to contact the service provider and requests the service by using the arbitrary string (the tourist's encryption key string) to identify the service required; the tourist also identifies the time period for which it is entitled to receive the service. In return, the service provider transmits the service encrypted by the service name and the public data value for the service and time period concerned. The tourist's trusted application decrypts the service on the PDA using the corresponding decryption key. The service provider doesn't need to perform any authentication or authorization checks on the tourist as only a party with a valid decryption key obtained from the authority can decrypt the service.

The end of each 1-hour slot corresponds to the end of one or more service time periods. Where one of the expiring time periods is the one for which the tourist has the decryption key, the tourist is thereafter unable to access the service as service data is thereafter encrypted using a different data set to the one used for generating the decryption key possessed by the tourist.

It will be appreciated that many other variants are possible to the above described embodiments of the invention. For example, the present invention is not limited to the QR IBE method used in the above-described embodiments and other analogous cryptographic methods can be used such as IBE methods based on bilinear mappings or RSA technology.

With respect to the service time periods, the beginning and/or end of one or more periods can be controlled by events other than clock events; such events are termed “non-clock” events for convenience of reference. Non-clock events include, for example, the start and finish of a sporting occasion whereby a service time period delimited by these events can be defined in correspondence to the duration of the sporting occasion. Where, as in the foregoing example, a service time period is of unpredictable duration, the authorisation authority should be arranged to immediately notify the service provider of the termination of the service period so that the service provider can cease using the public data N for that period when sending out encrypted service data; typically, the service provider will then switch to using the public data value for the next service time period, this value having been provided by the authority 40 either in advance or when the service provider is notified of the termination of the service time period just ended.

The authorisation authority 40 can also be arranged to force a change at any time in the public data value being used by the service provider whereby to immediately revoke authorisation for the party 20 to use the service; in effect, this makes all service time periods of unpredictable duration.

It will be appreciated that the party 20 does not need to be in the possession of a decryption key at the time of requesting a service from the service provider as the party can seek to obtain the required key from the authorisation authority after having received the encrypted service data.

The service provider can encrypt data to be sent to the party during a particular time period in advance of that time period provided it knows the encryption key string and uses the public data value for that particular time period (as opposed to the public data value for the time period current at the time the encryption is effected).

In situations where service users are likely to be present for receiving a service over a limited time period (such as is the case with tourists who will normally only stay in a region for a period of one or two weeks), the data sets could be repeated after a period of time (such a month); however, this is not preferred.

1. A method of regulating access to at least one service provided by at least one service provider, wherein a service authoriser:
generates for each of multiple service time periods a different respective data set comprising private data and related public data; and
determines whether a party is entitled to receive a said service for a particular said time period and, if so, provides that party with a decryption key for accessing the service during said particular time period, the decryption key being generated by the authoriser in dependence on both an arbitrary encryption key string associated with the service, and the private data of the data set for said particular time period.

2. A method according to claim 1, wherein a said service provider provides said party with encrypted data which the party is required to decrypt to receive the service for a current said time period, the encrypted data being data encrypted based on said encryption key string and the public data of the data set for said current time period, and the party only being able to decrypt the encrypted data using said decryption key provided by the authoriser where the said particular time period is said current time period.

3. A method according to claim 2, wherein the data that is encrypted by the service provider is arbitrary data, said party being required to decrypt and return this data as evidence of its entitlement to receive the service for the current time period before the service provider provides said service to the party.

4. A method according to claim 2, wherein the data that is encrypted by the service provider is a data component of the service.

5. A method according to claim 4, wherein the data component comprises at least one of software and digital media content.

6. A method according to claim 1, wherein the encryption key string is formed using at least an identifier of said service.

7. A method according to claim 6, wherein the service identifier is generated by said party and provided by it both to the authoriser to obtain the decryption key for enabling the party to receive the service during said particular time period, and to the service provider concerned.

8. A method according to claim 7, wherein the service provider maps the service identifier to the most suitable one of multiple services it can provide in order to determine the service required by said party.

9. A method according to claim 6, wherein the service identifier is generated by one of the authoriser and the service provider concerned and made available both to the other of the service provider and authoriser, and to said party.

10. A method according to claim 1, wherein plural said data sets are generated in advance of the time periods to which they relate and the public data of these data sets are made available in advance of those time periods to at least one of said party and said at least one service provider.

11. A method according to claim 1, wherein the time for which said service is available is divided into time slots, each said time period for which a respective said data set is generated corresponding to a respective one of said time slots.

12. A method according to claim 1, wherein the time for which said service is available is divided into time slots, at least one of said time periods for which a respective said data set is generated corresponding to a combination of multiple said time slots.

13. A method according to claim 1, wherein the time for which said service is available is divided into time slots, and wherein for a group of successive time slots, each time slot and each of every possible time-ordered combination of at least two adjacent time slots constitutes a respective said time period for which a corresponding data set is generated by the authoriser, the authoriser providing a single decryption key to said party upon determining that the party is entitled to receive said service for any time slot or time-ordered combination of time slots within said group.

14. A method according to claim 1, wherein at least one of the start and finish of a said time period is determined by the occurrence of a non-clock event.

15. A method according to claim 1, wherein the decryption key provided to said party in respect of a time period for which it is entitled to receive said service, is securely stored in trusted platform equipment of said party such that the decryption key is not accessible in cleartext form to the party but is usable to decrypt said encrypted data in the trusted platform.

16. A method according to claim 1, wherein the authoriser operates to determine the entitlement of said party to any of multiple services for any of said multiple time periods, and to provide the party with at least one decryption key appropriate for the or each service and the or each time period for which the party has been determined as entitled, the decryption keys for each of said multiple services in the same time period being different from each other.

17. A method according to claim 16, wherein the authoriser uses the private data of the same data set for each service during the same time period when generating the decryption key to be provided to said party, the encryption key strings used for each of said multiple services being different from each other.

18. A method according to claim 16, wherein the authoriser generates a respective data set for each combination of service and time period, the authoriser using the private data of the data set for the appropriate service and time period when generating the decryption key to be provided to said party.

19. A computing entity for regulating access to at least one service provided by at least one service provider, the computing entity comprising:
first means for generating for each of multiple service time periods a different respective data set comprising private data and related public data;
second means for determining whether a party is entitled to receive a said service for a particular said time period;
third means for providing a party that the second means has determined is entitled to receive the service, with a decryption key for accessing the service during said particular time period, the third means including key-generating means for generating the decryption key in dependence on both an arbitrary encryption key associated wit the service, and the private data of the data set for said particular time period.

20. A computing entity according to claim 19, wherein the encryption key string is formed using at least an identifier of said service.

21. A computing entity according to claim 20, wherein the computing entity is arranged to receive said service identifier from said party.

22. A computing entity according to claim 20, wherein the computing entity is arranged to generate the service identifier and to make it available to the service provider concerned and said party.

23. A computing entity according to claim 19, wherein the computing entity is arranged to use said first means to generate plural said data sets in advance of the time periods to which they relate, the computing entity being further arranged to make the public data of these data sets available in advance of those time periods to at least one of said party and the service provider concerned.

24. A computing entity according to claim 19, wherein the time for which said service is available is divided into time slots, each said time period for which a respective said data set is arranged to be generated by said first means corresponding to a respective one of said time slots.

25. A computing entity according to claim 19, wherein the time for which said service is available is divided into time slots, at least one of said time periods for which a respective said data set is arranged to be generated by said first means corresponding to a combination of multiple said time slots.

26. A computing entity according to claim 19, wherein the time for which said service is available is divided into time slots, and wherein for a group of successive time slots, each time slot and each of every possible time-ordered combination of at least two adjacent time slots constitutes a respective said time period for which said first means is arranged to generate a corresponding data set, the third means being arranged to provide a single decryption key to said party upon the second means determining that the party is entitled to receive said service for any time slot or time-ordered combination of time slots within said group.

27. A computing entity according to claim 19, wherein the first means includes means for determining the occurrence of a non-clock event and for using this occurrence to start or finish of a said time period.

28. A computing entity according to claim 19, wherein the second means is arranged to determine the entitlement of said party to any of multiple services for any of said multiple time periods, the third means being arranged to provide said party with at least one decryption key appropriate for the or each service and the or each time period for which the party has been determined as entitled, the decryption keys for each of said multiple services in the same time period being different from each other.

29. A computing entity according to claim 28, wherein the key-generating means is arranged to use the private data of same data set for each service during the same time period when generating the decryption key to be provided to said party, the encryption key strings used for each of said multiple services being different from each other.

30. A computing entity according to claim 28, wherein the first means is arranged to generate a respective data set for each combination of service and time period, the key-generating means being arranged to use the private data of the data set for the appropriate service and time period when generating the decryption key to be provided to said party.

31. A system for regulating access to a service provided by a service provider, the system comprising:
a first computer entity for authorising access to said service, comprising:
first means for generating for each of multiple service time periods a different respective data set comprising private data and related public data;
second means for determining whether the party is entitled to receive the service for a particular said time period;
third means for providing a party that the second means has determined is entitled to receive the service, with a decryption key for accessing the service during said particular time period, the third means including key-generating means for generating the decryption key in dependence on both an arbitrary encryption key associated with the service, and the private data of the data set for said particular time period;
a second computer entity, associated with the service provider, and arranged to provide said party with encrypted data which the party is required to decrypt to receive the service for a current said time period, the second computer entity being arranged to form said encrypted data by encrypting data based on said encryption key string and the public data of the data set for said current time period; and
a third computer entity, associated with said party, and arranged to use the decryption key provided by the first computer entity to decrypt the encrypted data provided by the second computer entity, the third computer entity only being able to decrypt the encrypted data using said decryption key where the said particular time period is said current time period.

32. A system according to claim 31, wherein the data that is encrypted by the second computer entity is arbitrary data, said third computer entity being arranged to decrypt and return this data as evidence of its entitlement to receive the service for the current time period, and the third computer entity being arranged to respond to receipt of the correctly decrypted data from the third computer entity to provide said service to the party.

33. A system according to claim 31, wherein the data that the second computer entity is arranged to encrypt is a data component of the service.

34. A system according to claim 33, wherein the data component comprises at least one of software and digital media content.

35. A system according to claim 31, wherein the encryption key string is formed using at least an identifier of said service.

36. A system according to claim 35, wherein the third computer entity is arranged to provide said service identifier both to the first computer entity to obtain the decryption key for the service for said particular time period, and to the second computer entity.

37. A system according to claim 36, wherein the second computer entity is arranged to maps the service identifier to the most suitable one of multiple services it can provide in order to determine the service required by said party.

38. A system according to claim 35, wherein one of the first and second computer entities is arranged to generate the service identifier and to make it available both to the other of the second and first computer entities, and to the third computer entity.

39. A system according to claim 31, wherein the first computer entity is arranged to use said first means to generate plural said data sets in advance of the time periods to which they relate, the first computer entity being further arranged to make the public data of these data sets available in advance of those time periods to at least one of the second and third computer entities.

40. A system according to claim 31, wherein the time for which said service is available is divided into time slots, each said time period for which a respective said data set is arranged to be generated by said first means of the first computer entity corresponding to a respective one of said time slots.

41. A system according to claim 31, wherein the time for which said service is available is divided into time slots, at least one of said time periods for which a respective said data set is arranged to be generated by said first means of the first computer entity corresponding to a combination of multiple said time slots.

42. A system according to claim 31, wherein the time for which said service is available is divided into time slots, and wherein for a group of successive time slots, each time slot and each of every possible time-ordered combination of at least two adjacent time slots constitutes a respective said time period for which said first means of the first computer entity is arranged to generate a corresponding data set, the third means of the first computer entity being arranged to provide a single decryption key to said third computer entity upon the second means of the first computer entity determining whether the party is entitled to receive said service for any time slot or time-ordered combination of time slots within said group.

43. A system according to claim 31, wherein the first means of the first computer entity includes means for determining the occurrence of a non-clock event and for using this occurrence to start or finish of a said time period.

44. A system according to claim 31, wherein the third computer entity is a trusted platform arranged to securely store the decryption key provided to it by the first computer entity such that the decryption key is not externally accessible in cleartext form but is usable to decrypt said encrypted data in the trusted platform.

45. A computing entity according to claim 31, wherein the second means of the first computer entity is arranged to determine the entitlement of said party to any of multiple services for any of said multiple time periods, the third means of the first computer entity being arranged to provide the third computer with at least one decryption key appropriate for the or each service and the or each time period for which the party has been determined as entitled, the decryption keys for each of said multiple services in the same time period being different from each other.

46. A system according to claim 45, wherein the key-generating means of the first computer entity is arranged to use the private data of same data set for each service during the same time period when generating the decryption key to be provided to the third computer entity, the encryption key strings used for each of said multiple services being different from each other.

47. A system according to claim 45, wherein the first means of the first computer entity is arranged to generate a respective data set for each combination of service and time period, the key-generating means of the first computer entity being arranged to use the private data of the data set for the appropriate service and time period when generating the decryption key to be provided to said party.
